SEQUENCE LISTING (6 sequences)

SEQ ID NO: 1 - DNA, 15 bp, Artificial Sequence
  primer
acgagcaatggagtg

SEQ ID NO: 2 - DNA, 15 bp, Artificial Sequence
  primer
tcgcaagtggcaagc

SEQ ID NO: 3 - DNA, 15 bp, Artificial Sequence
  primer
tggactgctggactg

SEQ ID NO: 4 - DNA, 15 bp, Artificial Sequence
  primer
cactccattgctcgt

SEQ ID NO: 5 - DNA, 15 bp, Artificial Sequence
  primer
gcttgccacttgcga

SEQ ID NO: 6 - DNA, 15 bp, Artificial Sequence
  primer
cagtccagcagtcca

(19) United States
(12) Patent Application Publication
(10) Pub. No.: US 2011/0275540 A1
(43) Pub. Date: Nov. 10, 2011

(54) New Molecularly Imprinted Polymer and Method for its Production

(76) Inventor: Sten Ohlson, Malmo (SE)

(21) Appl. No.: 13/145,460

(22) PCT Filed: Jan. 22, 2010
(86) PCT No.: PCT/SE10/50058

§ 371 Date: Jul. 20, 2011

Related U.S. Application Data
(60) Provisional application No. 61/146,434, filed on Jan. 22, 2009.

(51) Int. Cl. C40B 40/04; C40B 50/06; C40B 50/14; C40B 50/00

(52) U.S. Cl. 506/15; 506/23; 506/26; 506/30

(57) ABSTRACT

The present invention relates to a molecularly imprinted polymer and a method of producing the same using complementary oligo- and/or polynucleotides.

### TECHNICAL FIELD

The present invention relates to molecularly imprinted polymers, including methods and preparations, characterized by polymerization of a number of complementary nucleotides (mono- to polynucleotides) carrying functional groups able to bind to a target molecule.

### BACKGROUND ART

In chemistry, molecular imprinting is a technique to create template-shaped cavities in polymer matrices with memory of the template molecules to be used in molecular recognition. The specific polymers (imprints) bind selectively to target molecules. Molecular imprinting usually comprises of the followings steps: 1) Functional monomers are preassembled around the template by covalently- or non-covalently interactions to binding sites of the template. 2) Polymerization including cross linking is initiated, resulting in a polymer that is complementary in shape and binding sites to the template. 3) The template is removed from the polymer (imprint) and the imprint functions then as a binder for the target molecule or similar molecules. The technology has received wide attention for the last thirty years as is evidenced by the number of publications (several thousands), patents and patent applications (hundreds) and reviews in the field (1-12).

Molecular imprinting shows promise in diverse areas as diagnostics (to replace immunoassays), sensors and biosensors, separation materials, artificial enzymes, in drug discovery (as receptor mimics and for screening) and drug release. Even though molecular imprinting is showing significant advantages as a robust, easy-to-produce and price-effective technology producing highly stable materials, it faces major challenges. To become a realistic alternative to biological methods to produce recognition elements exemplified with monoclonal- and recombinant antibodies, molecular imprinting still needs to overcome some major hurdles associated with the technology. These include factors such as presence of non-specific binding, low capacity and selectivity, limited reproducibility from batch-to batch and challenges in scale-up of production, heterogeneous expression of binding sites, limited binding activity in water-based media such as in physiological solutions and applicability with biological macromolecules. The purpose of this invention is to design and produce a polymer that is based on polynucleotides of different sizes that will alleviate some of the drawbacks with traditional synthetic imprinted polymers.

### SUMMARY OF INVENTION

An object of the present invention is to produce a DNA molecular imprint.

The method comprises the following steps:
selecting a template molecule,
bringing the template molecule in contact with functional groups each linked to a starter oligonucleotide allowing the functional groups to bind to the template molecule,
adding a single stranded oligo- or polynucleotide library and allow the oligo- or polynucleotides of the library showing complementarity to the starter oligonucleotides linked to the functional groups to hybridize,
forming a complementary strand by a polymerizing reaction wherein the oligonucleotides linked to the functional groups serve as primers and thereby forming a nucleotide based double-stranded polymer, and
removing the template molecule leaving the functional groups in spatial and binding complementarity towards the accessible binding sites of the template molecule.

The attached set of claims is hereby incorporated in its entirety.

### DESCRIPTION OF EMBODIMENTS

Before the present invention is described, it is to be understood that the terminology employed herein is used for the purpose of describing particular embodiments only and is not intended to be limiting, since the scope of the present invention will be limited only by the appended claims and equivalents thereof.

It must be noted that, as used in this specification and the appended claims, the singular forms “a,” “an,” and “the” include plural referents unless the context clearly dictates otherwise.

Also, the term “about” is used to indicate a deviation of +/−2% of the given value, preferably +/−5%, and most preferably +/−10% of the numeric values, where applicable.

In the context of the present invention the term “oligonucleotide” refers to a deoxyribonucleic acid (DNA) or ribonucleic acid (RNA) sequence composed of two or more covalently linked nucleotides. Oligonucleotides are classified as deoxyribooligonucleotides or ribooligonucleotides. Fragments containing up to 50 nucleotides are generally termed oligonucleotides, and longer fragments are called “polynucleotides”. The terms “oligonucleotide” and “polynucleotide” also encompass any other nucleobase containing polymer, such as, without limitation, peptide nucleic acids (PNA), peptide nucleic acids with phosphate groups (PHONA), locked nucleic acids (LNA), morpholino-backbone oligonucleotides and oligonucleotides or polynucleotides having backbone sections with alkyl linkers or amino linkers. Oligonucleotides and polynucleotides also include naturally occurring nucleotides, modified nucleotides or mixtures thereof. A modified nucleotide is a nucleotide that includes a modified heterocyclic base, a modified sugar moiety or a combination thereof.

The term “oligonucleotide or polynucleotide library” relates to a collection of oligonucleotide sequences or gene sequences. In the context of the present invention the term “oligonucleotide or polynucleotide library” includes conventional genomic and cDNA libraries well known to the skilled person as well as randomized libraries comprising variations of a gene or a fragment of a gene, which is screened, for example, for novel activity. Thus, the library can comprise unknown or known DNA sequences or DNA sequences construed to be complementary to the known starter oligonucleotides.

In the context of the present invention a molecular imprinted polymer is a polymer that is formed in the presence of a template molecule that is extracted afterwards, thus leaving complementary cavities behind.

In the context of the present invention the template molecule can be a target molecule to be captured, it can correspond to the entire structure of the target molecule, or the template molecule can correspond to a portion of the target molecule. A template molecule “corresponds” to the entire structure of the target molecule if it possesses the structural features of the target molecule as described below.

The template molecule can possess structural features of a molecule by way of structural identity with the molecule or portion. Alternatively, the template molecule can possess structural features of the molecule or portion by mimicking those structural features of the molecule. The only requirement of the template molecule is that it comprises a three-dimensional structure that is similar enough to the structure of the molecule or portion so that the molecule or portion specifically fits within a cavity formed by the template molecule.

A template molecule can correspond to a target molecule without being identical to the target molecule. Those of skill in the art will recognize that a template molecule need not have exact structural identity with the target molecule in order to “correspond” to it. Often, a template molecule may incorporate topographic substitutions. A substitution is “topographic” if the topography of the template molecule creates a cavity that binds the corresponding target molecule. Preferably, a template with a topographic substitution creates an imprint that specifically binds the corresponding target molecule. Template molecules comprising topographic substitutions, and that therefore do not correspond identically to the target molecule, are said to correspond substantially to the target molecule.

The imprints of the present invention can be used to detect, capture, isolate, analyze and/or quantify any target molecule. Target molecules specifically include any species that has a three-dimensional topography that is capable, at least in part, of binding cavities in a matrix material that correspond at least a portion of the three-dimensional topography of the target. Typical examples include, by way of example and not limitation, organic molecules, small molecules, therapeutic molecules, polymers, macromolecules and biological macromolecules. However, targets are not limited to molecular substances, as the imprints of the present invention can be used to capture substances as large as viruses and bacteria or even larger objects.

In several important embodiments, target molecules are macromolecules. Macromolecules that can be captured, isolated, detected, analyzed and/or quantified using the method of the invention include any type of macromolecule from which a template molecule can be designed and constructed according to the principles taught herein. Virtually any type of macromolecule can be captured, isolated, detected, analyzed and/or quantified using the methods and compositions of the invention. Non-limiting examples include biological polymers such as polypeptides, polynucleotides and polysaccharides, non-biological polymers such as polyesters, polyethers, polyurethanes, block co-polymers, and other polymers known to those of skill in the art. Non-limiting examples also include biological and non-biological non-polymeric compounds such as antibiotics, steroids, natural products, dyes, etc. Thus, non-limiting examples of the myriad types of macromolecular that may be captured, isolated, detected, analyzed and/or quantified using the methods and compositions of the invention include cytokines, hormones, growth factors, enzymes, cofactors, ligands, receptors, antibodies, carbohydrates, steroids, therapeutics, antibiotics, and even larger structures such as viruses or cells, and other macromolecular targets that will be apparent to those of skill in the art.

In the context of the present invention the term linker relates to a spacer element that separates the functional group and the oligonucleotide. The linker may for example be comprised of a polymer of a suitable number of amino acid residues, although it is to be understood that any other molecule which functions as a spacer element can be used. The size and nature of the linker is dependent on the surrounding elements (such as the functional group), as the primary function thereof is to provide a sufficient spacing between the functional group and the oligonucleotide. The linker may be a natural or synthetic nucleic acid polymer but may also be any suitable synthetic or natural polymer. The linker is preferably inert meaning that it will not undergo any undesired chemical reaction and does not participate in the chemical/biochemical reactions performed during the production of the imprint or the use of the imprint.

In the context of the present invention the term “spatial and binding complementarity” relates to single or double stranded oligonucleotides or polynucleotides being fixed in a desired three dimensional structure or position by appropriate cross linking and/or polymerization. The desired three dimensional structure or position is determined by the template used to produce the imprint.

In the context of the present invention the term “functional group” is defined as chemical moieties able to bind covalently or non-covalently to a target molecule. Non-limiting examples of functional groups are carboxylate ions, hydroxyl groups , carbonyl groups, amines, amides, amidines, aromatic groups such as phenyls and pyridines, alkyl groups and imidazoles and for covalent binding non-limiting examples are carbonyl groups and pairs of hydroxyl groups (1,2 and 1,3-diol functionality) utilizing boronate esters. Further non-limiting examples are amino acids, carbohydrates (mono and oligosaccharides), nucleotides or oligonucleotides, peptides and polypeptides, polyelectrolytes, carboxylic acids, sulphoderivatives such as sulfonamide, phosphoderivatives such as phosphoamide, hydroxyls, aldehydes, ketones, ethers, nitriles, aromatic- and alkyl hydrocarbons, thiols, boronates and imides.

The present invention relates to a method of producing molecularly imprinted polymers, the method comprising the following steps:
selecting a template molecule,
providing at least two starter oligonucleotides each linked to a functional group and wherein said at least two starter oligonucleotides being the same or different,
bringing the template molecule in contact with the functional groups each linked to said starter oligonucleotides allowing the functional groups to bind to the template molecule,
adding a single stranded oligo- or polynucleotide library allowing the oligo- or polynucleotides of the library showing complementarity to the starter oligonucleotides linked to the functional groups to hybridize in order to form a complex between said at least two starter oligonucleotides and oligo- or polynucleotide(s) from the library,
forming a complementary strand by a polymerizing reaction wherein the starter oligonucleotides linked to the functional groups serve as primers and thereby forming a nucleotide based double-stranded complex or polymer, and
removing the template molecule leaving the functional groups in spatial and binding complementarity towards the accessible binding sites of the template molecule.

The functional groups attached to the at least two starter oligonucleotides are preferably attached to the 3-end of one starter oligonucleotide and to the 5-end of the other starter oligonucleotide. The starter oligonucleotides have a length of up to about 1 to 100 nucleotides, preferably about 1 to 50 nucleotides and more preferably of about 5 to 40 and even more preferable of about 8 to 35 nucleotides.

The functional groups attached to said at least two starter oligonucleotides may be the same or different and can be identified by sequencing the corresponding linked oligonucleotide.

According to the invention, a template of any size (immobilized or not to a soluble or insoluble matrix) is reacted with a number (typically about 50-100) of small organic or inorganic functional moieties or groups each linked to a starter oligonucleotide (typically but not exclusively coupled to phosphate groups with an appropriate linker or not) carrying a unique sequence of purine- or pyrimidine bases. A target molecule is used as template molecule for the imprinted polymer.

In a next step a library of any size (typically 10⁴-10⁷ compounds) of single stranded oligo- or polynucleotides (DNA or RNA based) is added to template with preassembled oligonucleotide tagged functional groups (i.e. oligonucleotides to which functional groups are bound). A certain number of these oligo- or polynucleotides show complementarity to the at least two starter oligonucleotides and as such they hybridize with preassembled nucleotides of the template-functional group intermediates. A complementary nucleotide strand is now produced by a polymerase reaction joining together the starter oligonucleotides (serving as primers) of the preassembled functional groups to the original template. In this way a nucleotide based double-stranded polymer is formed where the functional groups are in spatial and binding complementarity towards the accessible binding sites of the template. At this stage as an option, unbound oligo- or polynucleotides and/or nucleotide tagged functional groups can be washed out by affinity separation if the template is immobilized to a suitable matrix such as a soluble or insoluble support. Suitable matrices are well known to the skilled person. The nucleic based imprint is recovered by elution as either a single-stranded or double stranded molecule. Identity of the imprinted functional groups can be established by sequencing the corresponding oligo- or polynucleotide tags (sequencing methods are well known, see Current Protocols in Molecular Biology and Protein Science, Wiley InterScience, 2007.).

The nucleotide based double stranded polymer imprint can also be amplified before or after removing the template. The amplification can be performed by polymerase chain reactions (PCR) (such method is well known, see Current Protocols in Molecular Biology and Protein Science, Wiley InterScience, 2007.) of the nucleotide based imprint (with our without template) in the presence of the identified tag of oligonucleotides attached to the functional groups of the nucleotide based imprint now serving as primers. By PCR the nucleotide based imprint is amplified many times producing exact copies of the original imprint. After removal of the template if not removed before amplification, the nucleotide based imprint is now able to specifically rebind to the original template or structural analogues with a diversity of affinities.

In the amplifying step preferably primers hybridizing to the sense and antisense strand of the DNA are used. Preferably at least one of the primers is labeled in order to be able to separate the two DNA strand after amplification and denaturation. A non-limiting example of such a label is biotinyl whereby streptavidin-conjugated magnetic beads can be used to extract the biotinylated strands. Using streptavidin-biotinylated labeling is well known to the skilled person as well as other labeling and separating methods (See Current Protocols in Molecular Biology and Protein Science, Wiley InterScience, 2007.).

After removing the unlabelled strand a primer extension reaction can be performed using primers/oligonucleotides to which functional groups corresponding to functional groups that are known to bind to the template or of which the identity has been established as mentioned above.

As a final step before removing the template possible gaps between primers and the synthesized strand are ligated for example by using a ligase, such as T4 DNA ligase (Fermentas) or any other suitable ligase.

In one embodiment of the inventive method the functional groups are attached to the oligonucleotides by a linker, preferably an inert linker.

The oligonucleotide attached to the functional groups comprises ribose and/or deoxyribose and about 1-100 nucleotides.

The present invention also relates to a molecularly imprinted polymer. The molecularly imprinted polymer comprises functional groups that are in spatial and binding complementarity towards binding sites of a template molecule corresponding to the template molecule that was used when the molecularly imprinted polymer was produced, and said functional groups are connected by polymerized nucleotides.

The functional groups of the molecularly imprinted polymer are selected from the group consisting of amino acids, carbohydrates (mono and oligosaccharides), nucleotides or oligonucleotides, peptides and polypeptides, polyelectrolytes, carboxylic acids, amines, amides, sulphoderivatives such as sulfonamide, phosphoderivatives such as phosphoamide, hydroxyls, aldehydes, ketones, ethers, nitriles, aromatic- and alkyl hydrocarbons, thiols, boronates and imides. Further, the functional groups are able to bind covalently or non-covalently to a template molecule and to mediate a metal chelate coordinated binding to the template molecule. The functional groups can also be joined to the polymerized nucleotides with an inert linker.

In one embodiment the invention relates to a molecular imprinted polymer produced by the method described herein.

The molecularly imprinted polymer according to the invention is preferably composed of single-stranded or double-stranded nucleotide chains and is preferably soluble in aqueous compositions.

All current techniques of molecular biology are available to modify the nucleotide based imprint according to desired characteristics of the imprint polymer. For example chemical labels such as biotin and digoxygenin can be introduced into the nucleotide based imprint for use of the imprint as a chemical probe. The nucleotide based imprint has the following characteristics: 1) it can be produced in any sizes according to the sizes of the nucleotide chain of the added strands. 2) The imprint should be soluble in various solvents including water-based media. 3) Imprints can be produced as identical imprints as polymers in almost unlimited quantities. 4) It can be derivatized with all available techniques of molecular biology. 5) The imprint can be produced with a diversity of homogeneous binding sites in a broad affinity range (association constant (Kₐ>10³ M⁻¹). 6). The imprint should be flexible and it should bind dynamically to the target. 7) The target epitope can be present as small to large molecules.

In summary, the current invention deals with the construction of a nucleotide-based polymer to be used in molecular imprinting for various purposes. It is anticipated that these polymers can be used favorably in a number of industrial applications as ligands, receptors and catalytic reagents where there is a need for reproducible, identical, highly selective and water-soluble molecularly imprinted polymers.

The invention will know be further described in the following non-limiting example.

### EXAMPLE

The following is a contemplated a typical example of how the invention can be carried out for the production of a DNA-imprint (DNAbody):

Materials:

The following oligonucleotides (primers) with and without functional groups or labeled are used:

SEQ ID NO: 1
5′-ACGAGCAATGGAGTG-3′ (with and without conjugated
boronic acid)
SEQ ID NO: 2
5′-TCGCAAGTGGCAAGC-3′ (with and without conjugated
alkyl group)
SEQ ID NO: 3
5-TGGACTGCTGGACTG-3′ (with and without conjugated
amine group)
SEQ ID NO: 4
5′-CACTCCATTGCTCGT-3′ (biotinylated at the 5′-end)
SEQ ID NO: 5
5′-GCTTGCCACTTGCGA-3′ (biotinylated at the 5′-end)
SEQ ID NO: 6
5-CAGTCCAGCAGTCCA-3′ (biotinylated at the 5′-end)

The exact primer length can be varied but typically 15 bases can be used. All primers were produced by Invitrogen and/or Scandinavian Gene Services.

### Methods

Production of a DNA-imprint:

Protocols for standard molecular biology procedures/immunological assays such as PCR and ELISA can be found in Current Protocols in Molecular Biology/Protein Science, Wiley InterScience.

The description below is for the production of a DNA-imprint having a boronic acid at the 5′-end and an amine group at the 3′-end but as it is a general protocol it can be applied for production of any DNA-imprint with different derivatized primers. The target is in this case a protein such as mouse IgG (Sigma-Aldrich) which is biotinylated according to standard procedures (Fisher Scientific Inc.) The biotinylated mouse IgG is incubated with the boronic acid-conjugated (SEQ ID NO:1) and amine group-conjugated (SEQ ID NO:3) primers for one h in phosphate buffered saline pH=7.4 (PBS) at 20° C. Unbound primers are removed by three PBS washes using streptavidin-conjugated magnetic beads (Invitrogen). A denatured genomic E. coli DNA library (Affymetrix/USB), fragmented to <1000 bp, is hybridized to the primer sequences for one h in PBS at 20-50° C. Again, three PBS washes using streptavidin-conjugated magnetic beads are performed to discard any unbound DNA. A complementary strand to the hybridized DNA is produced in appropriate buffer using DNA polymerase I (Fermentas) at 25° C. for one h. The mixture is then heated to 95° C. and the denatured protein is removed using the streptavidin-conjugated magnetic beads.

Double stranded (ds) DNA is amplified in a PCR reaction using the sense (SEQ ID NO:1) and biotinylated antisense (SEQ ID NO:6) primers. All PCR reactions are amplified using Pfu DNA polymerase (Fermentas) with an optimized amplification program. PCR products are analyzed on a 0.8% agarose gel, denatured and the biotinylated strand separated from its complementary strand using streptavidin-conjugated magnetic beads. The boronic acid-conjugated (SEQ ID NO:1) and amine group-conjugated (SEQ ID NO:3) primers are used in a primer extension reaction, to produce a complementary strand to the biotinylated single stranded (ss) DNA strand. This reaction is performed in appropriate buffer at 20° C. for one h using T4 DNA polymerase (Fermentas).

In the final step, to fill gaps between primers and synthesised strand a ligation is performed using T4 DNA ligase (Fermentas). By denaturing the product with heat, the biotinylated template is removed with streptavidin-conjugated magnetic beads.

### Detection of DNA-imprints:

For the detection of the IgG-specific DNA imprints, DNA-specific antibodies are used. The detection can be performed in a standard ELISA procedure, with the target protein coated to the plate followed by addition of the DNA-imprint and finally detection with an enzyme conjugated DNA-specific antibody. Alternatively amplification of the signal can be performed with an enzyme-conjugated secondary antibody.

The DNA-imprint, bound to the target IgG, can also be detected using PCR in the following way: Incubation of biotinylated IgG with DNA-imprints, washing and denaturation of protein using streptavidin-conjugated magnetic beads and heat at 95° C. The purified DNA-imprint is amplified in a PCR-reaction, using un-labeled sense and antisense primers followed by visualization on an agarose gel.

As a control experiment to demonstrate the specificity of the DNAimprint, the same procedure, as described above, is carried out without functionalized primers.

Although particular embodiments have been disclosed herein in detail, this has been done by way of example for purposes of illustration only, and is not intended to be limiting with respect to the scope of the appended claims that follow. In particular, it is contemplated by the inventor that various substitutions, alterations, and modifications may be made to the invention without departing from the spirit and scope of the invention as defined by the claims.

### REFERENCE

1. Takeuchi, T., and T. Hishiya, 2008. Molecular imprinting of proteins emerging as a tool for protein recognition. Organic & Biomolecular Chemistry 6:2459.
2. Ye, L., and K. Mosbach, 2008. Molecular imprinting: Synthetic materials as substitutes for biological antibodies and receptors. Chemistry of Materials 20:859.
3. Hansen, D. E. 2007. Recent developments in the molecular imprinting of proteins. Biomaterials 28:4178.
4. Janiak, D. S., and P. Kofinas. 2007. Molecular imprinting of peptides and proteins in aqueous media. Analytical and Bioanalytical Chemistry 389:399.
5. Li, W., and S. J. Li. 2007. Molecular imprinting: A versatile tool for separation, sensors and catalysis. In Oligomers Polymer Composites Molecular Imprinting, Vol. 206. SPRINGER-VERLAG BERLIN, Berlin, p. 191.
6. Alexander, C., H. S. Andersson, L. I. Andersson, R. J. Ansell, N. Kirsch, I. A. Nicholls, J. O'Mahony, and M. J. Whitcombe. 2006. Molecular imprinting science and technology: a survey of the literature for the years up to and including 2003. Journal of Molecular Recognition 19:106.
7. Mosbach, K. 2006. The Promise of Molecular Imprinting. Scientific American 295:86.
8. Marty, J. D., and M. Mauzac, 2005. Molecular imprinting: State of the art and perspectives. In Microlithography—Molecular Imprinting, Vol. 172. SPRINGER-VERLAG BERLIN, Berlin, p. 1.
9. Turiel, E., and A. Martin-Esteban. 2005. Molecular imprinting technology in capillary electrochromatography. Journal of Separation Science 28:719.
10. van Nostrum, C. F. 2005. Molecular imprinting: A new tool for drug innovation. Drug Discovery Today: Technologies 2:119.
11. Hilt, J. Z., and M. E. Byrne. 2004. Configurational biomimesis in drug delivery: molecular imprinting of biologically significant molecules. Advanced Drug Delivery Reviews 56:1599.
12. Piletsky, S. A., S. Alcock, and A. P. F. Turner. 2001. Molecular Imprinting: At the Edge of The Third Millennium. TRENDS in Biotechnology 19:9.

1. A method of producing molecularly imprinted polymers, the method comprising the following steps:
selecting a template molecule,
providing at least two starter oligonucleotides each linked to a functional group and wherein said at least two starter oligonucleotides being the same or different,
bringing the template molecule in contact with the functional groups each linked to said starter oligonucleotides allowing the functional groups to bind to the template molecule,
adding a single stranded oligo- or polynucleotide library allowing the oligo- or polynucleotides of the library showing complementarity to the starter oligonucleotides linked to the functional groups to hybridize in order to form a complex between said at least two starter oligonucleotides and a oligo- or polynucleotide from the library,
forming a complementary strand by a polymerizing reaction wherein the starter oligonucleotides linked to the functional groups serve as primers and thereby forming a nucleotide based double-stranded polymer, and
removing the template molecule leaving the functional groups in spatial and binding complementarity towards the accessible binding sites of the template molecule.

2. The method according to claim 1, wherein one of said at least two starter oligonucleotides has a functional group attached to its 3′-end and the other starter oligonucleotide has a functional group attached to its 5′-end.

3. The method according to claim 1, comprising a step of amplifying the nucleotide based double stranded polymers before or after removing the template.

4. The method according to claim 1, wherein the functional groups are selected from the group consisting of amino acids, carbohydrates (mono and oligosaccharides), nucleotides or oligonucleotides, peptides and polypeptides, polyelectrolytes, carboxylic acids, amines, amides, sulphoderivatives such as sulfonamide, phosphoderivatives such as phosphoamide, hydroxyls, aldehydes, ketones, ethers, nitriles, aromatic- and alkyl hydrocarbons, thiols, boronates and imides.

5. The method according to claim 1, wherein the template molecule immobilized to a soluble or insoluble support.

6. The method according to claim 1, wherein the functional groups are linked to the starter oligonucleotides with an inert linker.

7. The method according to claim 1, wherein the nucleotides of the starter oligonucleotides, attached to the functional groups, comprise ribose and/or deoxyribose.

8. The method according to claim 7, wherein the starter oligonucleotides attached to the functional groups comprises about 1-100 nucleotides.

9. The method according to claim 1, further comprising the step of identifying the functional groups by sequencing the corresponding linked oligonucleotide.

10. A molecularly imprinted polymer characterized in that said molecularly imprinted polymer comprises functional groups that are in spatial and binding complementarity towards binding sites of a template molecule corresponding to the template molecule that was used when the molecularly imprinted polymer was produced, and said functional groups are connected by polymerized nucleotides.

11. The molecularly imprinted polymer according to claim 10, wherein the functional groups are able to bind covalently or non-covalently to a template molecule.

12. The molecularly imprinted polymer according to claim 10, wherein the functional groups are selected from the group consisting of amino acids, carbohydrates (mono and oligosaccharides), nucleotides or oligonucleotides, peptides and polypeptides, polyelectrolytes, carboxylic acids, amines, amides, sulphoderivatives such as sulfonamide, phosphoderivatives such as phosphoamide, hydroxyls, aldehydes, ketones, ethers, nitriles, aromatic- and alkyl hydrocarbons, thiols, boronates and imides.

13. The molecularly imprinted polymer according to claim 10, wherein the functional group mediates a metal chelate coordinated binding to the template molecule.

14. The molecularly imprinted polymer according to claim 10, wherein the functional groups are joined to the polymerized nucleotides with an inert linker.

15. The molecularly imprinted polymer according to claim 10, wherein the imprint is composed of single-stranded or double-stranded nucleotide chains.

16. The molecularly imprinted polymer according to claim 10, wherein said the imprinted polymer is soluble in aqueous compositions.
